(19) United States
(12) Patent Application Publication
(10) Pub. No.: US 2013/0178240 A1
(43) Pub. Date: Jul. 11, 2013

(54) WIRELESS COMMUNICATION TERMINAL DEVICE AND METHOD OF CONTROLLING WIRELESS COMMUNICATION TERMINAL DEVICE

(71) Applicant: FUJITSU MOBILE COMMUNICATIONS LIMITED, Kawasaki-shi (JP)

(72) Inventor: Moriaki KIYOMOTO, Kunitachi (JP)

(73) Assignee: FUJITSU MOBILE COMMUNICATIONS LIMITED, Kawasaki-shi (JP)

(21) Appl. No.: 13/686,809

(22) Filed: Nov. 27, 2012

(30) Foreign Application Priority Data
Jan. 6, 2012 (JP) 2012-001268

(51) Int. Cl. H04W 52/24

(52) U.S. Cl. CPC H04W 52/246
USPC 455/522

(57) ABSTRACT

Wireless control units perform plural communication operations in parallel using plural different communication systems. Transmission power detecting units detect the transmission power in the communication operation using the respective communication systems performed by the wireless control units. A transmission power managing unit calculates the total sum of specific absorption rates in the respective communication operations based on the transmission power detected by the transmission power detecting units and determines lowering the transmission power of the communication operation using a predetermined communication system out of the plural communication systems when the calculated total sum of the specific absorption rates is greater than a predetermined reference value. Transmission power control units control the wireless control units to transmit data with the transmission power determined by the transmission power managing unit.

### CROSS-REFERENCE TO RELATED APPLICATION

This application is based upon and claims the benefit of priority of the prior Japanese Patent Application No. 2012-001268, filed on Jan. 6, 2012, the entire contents of which are incorporated herein by reference.

### FIELD

The embodiments discussed herein are related to a wireless communication terminal device and a method of controlling a wireless communication terminal device.

### BACKGROUND

Recently, various communication systems have been proposed for wireless communication. For example, CDMA (Code Division Multiple Access) and LTE (Long Term Evolution) are known as communication systems used in mobile phone devices. Hereinafter, these are referred to as a CDMA system and an LTE system, respectively. In addition, communication systems defined in the standard of fixed wireless communication (WiMAX (registered trademark): Worldwide Interoperability for Microwave Access) or the standard of wireless LAN (WiFi (registered trademark): Wireless Fidelity) and the like are used in mobile phone devices. Hereinafter, these are referred to as a WiMAX system and a WiFi system, respectively. Accordingly, it can be considered that communication operations using plural different communication systems are performed in parallel in wireless communication terminal devices that can perform communication operations using various communication systems.

When a communication operation is performed using a wireless communication terminal device, it is known that electromagnetic waves are generated from the wireless communication terminal device. The electromagnetic waves generated from the wireless communication terminal device may have an influence on a human body. Therefore, an SAR (Specific Absorption Rate) indicating an amount of energy absorbed by a human body is used as a reference representing how a human body is affected by the electromagnetic waves output from a wireless communication terminal device for a fixed time. Presently, a reference value of electromagnetic waves allowable for a human body is prepared. Specifically, an SAR reference in which the SAR is not greater than 2 W/kg is prepared as the allowable reference value of electromagnetic waves.

The following related arts have been proposed as countermeasures against the electromagnetic waves generated from wireless communication terminal devices. For example, related art of lowering the SAR value by adjusting an angle of an antenna is known. In addition, related art of using a directional antenna to make a voice call and using a non-directional antenna in a standby state is also known. In addition, related art of switching an antenna to a directional antenna having a small influence when the antenna and a head of a human body become close to each other is known. In addition, related art of changing transmission power depending on a distance from a human body is known. In addition, related art of calculating a three-dimensional SAR distribution from a measured electric field vector on an observation plane is known as related art of calculating an SAR.

Patent Document 1: Japanese Laid-open Patent Publication No. 2005-102205

Patent Document 2: Japanese Laid-open Patent Publication No. 2005-217836

Patent Document 3: Japanese Laid-open Patent Publication No. 2005-286741

Patent Document 4: Japanese Laid-open Patent Publication No. 2005-286627

Patent Document 5: Japanese Laid-open Patent Publication No. 2007-142830

Patent Document 6: Japanese Laid-open Patent Publication No. 2008-134218

However, when communication operations are performed in parallel using plural different communication systems, electromagnetic waves generated depending on the respective communication systems may be less than the SAR reference but the total electromagnetic waves generated from the wireless communication terminal device may exceed the SAR reference. Near-field communication systems such as WLAN or Bluetooth (registered trademark) have small transmission power and thus have a small influence on the SAR. On the contrary, data communication operations using the WiMAX system or the LTE system have large transmission power and thus have a large influence on the SAR. Therefore, when a data communication operation is performed using the WiMAX system or the LTE system while making a voice call using the CDMA system, it is difficult to set the total SAR to be less than the reference value due to the influence of electromagnetic waves generated in the communication operations using the communication systems.

Related arts as countermeasures against electromagnetic waves generated in a wireless communication terminal device are all directed to a decrease in SAR when a communication operation is performed using a single communication system and do not mention at all that plural communication operations are performed in parallel using plural different communication systems. Therefore, when communication operations are performed in parallel using different communication systems, it is difficult to set the total SAR to be less than the reference value. Even when the related art of calculating a three-dimensional SAR distribution is used, it is possible to simply acquire a three-dimensional SAR. When plural communication operations are performed in parallel using different communication systems, it is difficult to set the total SAR to be less than the reference value as a whole.

### SUMMARY

According to an aspect of an embodiment, a wireless communication terminal device includes: a wireless communication unit that performs a plurality of communication operations in parallel using a plurality of different communication systems; a transmission power detecting unit that detects transmission power in the communication operations using the respective communication systems performed by the wireless communication unit; and a control unit that calculates the total sum of specific absorption rates in the respective communication operations based on the transmission power detected by the transmission power detecting unit and that controls the wireless communication unit to lower the transmission power of the communication operation using a predetermined communication system out of the plurality of different communication systems when the calculated total sum of the specific absorption rates is greater than a reference value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a mobile phone device according to a first embodiment;

FIG. 2 is a diagram illustrating an example of information stored in a transmission power managing unit;

FIG. 3 is a diagram illustrating a correlation between transmission power and an SAR;

FIG. 4 is a diagram illustrating setting of a SAR reference value;

FIG. 5 is a diagram illustrating setting of a priority of a communication system;

FIG. 6 is a flowchart illustrating the flow of processes of controlling transmission power in the mobile phone device according to the first embodiment;

FIG. 7 is a diagram illustrating setting of a priority of an application;

FIG. 8 is a flowchart illustrating the flow of processes of controlling transmission power in a mobile phone device according to a third embodiment; and

FIG. 9 is a diagram illustrating the hardware configuration of a mobile phone device.

### DESCRIPTION OF EMBODIMENTS

Preferred embodiments of the present invention will be explained with reference to accompanying drawings.

The present invention is not limited to the wireless communication terminal device and the method of controlling a wireless communication terminal device according to these embodiments. Particularly, a mobile phone device will be described as an example of the wireless communication terminal device, but the wireless communication terminal device is not limited to the mobile phone device, as long as it can perform plural communication operations in parallel using plural communication systems.

### [a] First Embodiment

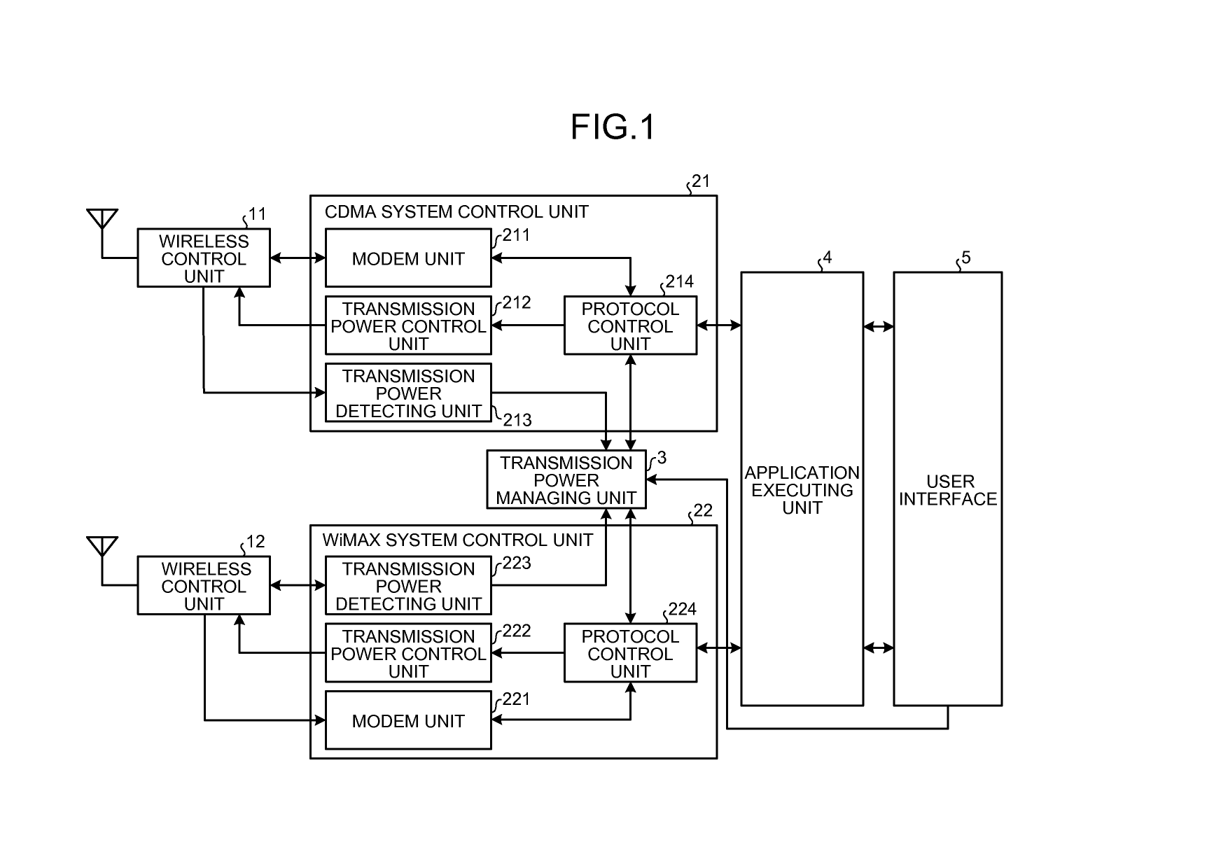

FIG. 1 is a block diagram illustrating a mobile phone device according to a first embodiment. As illustrated in FIG. 1, the mobile phone device according to this embodiment includes wireless control units 11 and 12, a CDMA system control unit 21, a WiMAX system control unit 22, a transmission power managing unit 3, an application executing unit 4, and a user interface 5.

The wireless control unit 11 receives input data of a baseband signal from a modem unit 211. Then, the wireless control unit 11 performs a frequency transformation or the like on the received data and generates data of a wireless signal. The transmission power of the wireless control unit 11 is controlled by a transmission power control unit 212. The wireless control unit 11 transmits the data of a wireless signal to an external device such as a base station with the transmission power controlled by the transmission power control unit 212 through communication using the CDMA system. Hereinafter, a wireless signal based on the CDMA system is referred to as a “CDMA signal”.

In addition, the wireless control unit 11 receives a CDMA signal via an antenna from a base station. The wireless control unit 11 performs a frequency transformation on the received CDMA signal into a baseband frequency and generates a baseband signal. The wireless control unit 11 outputs the CDMA signal as a baseband signal to the modem unit 211.

The wireless control unit 12 is almost equal to the wireless control unit 11 and description thereof will not be repeated. However, the wireless control unit 12 transmits data using a WiMAX system.

The CDMA system control unit 21 includes a modem unit 211, a transmission power control unit 212, a transmission power detecting unit 213, and a protocol control unit 214.

The modem unit 211 receives an instruction to transmit data from the protocol control unit 214 along with data to be transmitted. The modem unit 211 performs a demodulation process, a decoding process, and the like on a CDMA signal as a baseband signal. Then, the modem unit 211 outputs the CDMA signal, which has been subjected to the demodulation process and the decoding process to the protocol control unit 214.

In addition, the modem unit 211 receives the baseband signal of the data to be transmitted to an external device such as a base station from the protocol control unit 214. Then, the modem unit 211 performs an encoding process, a modulation process, and the like on the received baseband signal. Thereafter, the modem unit 211 outputs the baseband signal, which has been subjected to the encoding process and the modulation process to the wireless control unit 11.

The transmission power control unit 212 receives the value of transmission power used to transmit data from the protocol control unit 214. Then, the transmission power control unit 212 controls the wireless control unit 11 to transmit the data with the received value of transmission power.

The transmission power detecting unit 213 detects the transmission power used for the wireless control unit 11 to transmit the data. In addition, the transmission power detecting unit 213 outputs the detected transmission power to the transmission power managing unit 3.

The protocol control unit 214 performs a call sending process or a handover process in a communication operation using the CDMA system. In addition, the protocol control unit 214 receives data such as audio data from the application executing unit 4. Then, the protocol control unit 214 outputs the received data to the modem unit 211. When the total sum of SAR values is greater than the SAR reference value as described later, the protocol control unit 214 receives an instruction to control transmission power from the transmission power managing unit 3. In this embodiment, the protocol control unit 214 receives an instruction to lower the transmission power from the transmission power managing unit 3. Then, the protocol control unit 214 outputs the value of the transmission power which has been lowered in accordance with the instruction, to the transmission power control unit 212. Specifically, in this embodiment, the protocol control unit 214 acquires the transmission power for the subsequent data transmission by subtracting a predetermined value from the value of the transmission power used in the previous data transmission and outputs the acquired value of the transmission power to the transmission power control unit 212. For example, the predetermined value is 1 dB or 3 dB. For example, in this embodiment, it is assumed that the protocol control unit 214 lowers the transmission power by 1 dB.

The WiMAX system control unit 22 includes a modem unit 221, a transmission power control unit 222, a transmission power detecting unit 223, and a protocol control unit 224. The respective constituent units of the WiMAX system control unit 22 perform the same actions as the respective constituent units of the CDMA system control unit 21 using the WiMAX system as the communication system. Accordingly, the actions of the WiMAX system control unit 22 will not be described below.

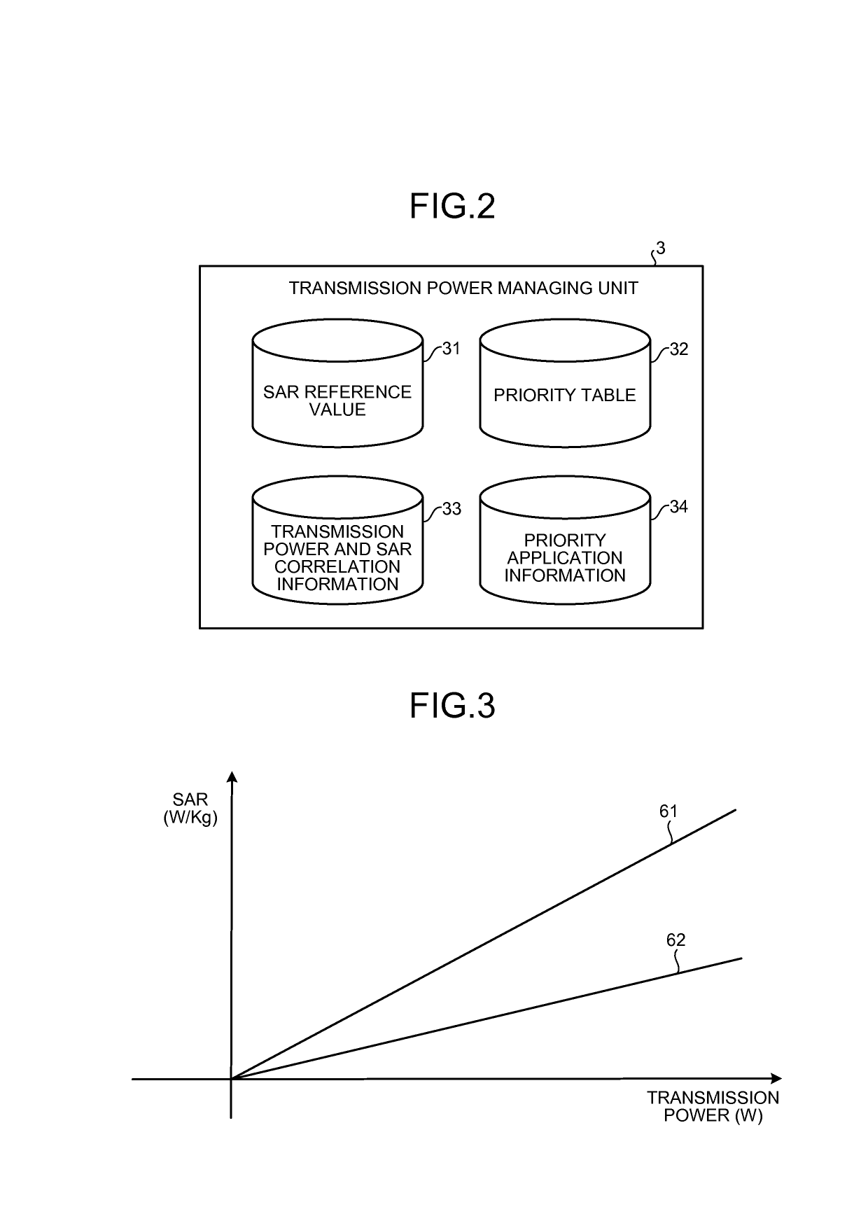

The transmission power managing unit 3 stores a variety of information used to calculate the transmission power, as illustrated in FIG. 2. FIG. 2 is a diagram illustrating an example of information stored in the transmission power managing unit 3. The transmission power managing unit 3 stores, for example, a SAR reference value 31, a priority table 32, transmission power and SAR correlation information 33, and priority application information 34. The SAR reference value 31 is an upper limit value of the SAR values due to electromagnetic waves generated in a mobile phone. The SAR reference value 31 is defined, for example, as 2.0 W/kg. The priority table 32 is a table in which priorities of respective communication systems are determined. The priority table 32 is determined, for example, so that the priority of the CDMA system is the highest and the priority of the WiMAX system is lower than that of the CDMA system. The transmission power and SAR correlation information 33 includes, for example, a graph representing a correlation, as illustrated in FIG. 3. FIG. 3 is a diagram illustrating the correlation between the transmission power and the SAR. In FIG. 3, the vertical axis represents the SAR value and the horizontal axis represents the transmission power. A graph 61 illustrated in FIG. 3 represents the correlation between the transmission power and the SAR in the CDMA system. In addition, a graph 62 represents the correlation between the transmission power and the SAR in the WiMAX system. As illustrated in FIG. 3, the SAR value increases in proportion to the transmission power in any of the graphs 61 and 62. In addition, the SAR value of the CDMA system is greater than that of the WiMAX system. Here, this embodiment employs the graph representing the correlation as the transmission power and SAR correlation information 33, but others such as a table or a correlation expression may be employed as long as the SAR value can be acquired from the transmission power therein.

The transmission power managing unit 3 receives the value of the transmission power of a communication operation using the CDMA system from the transmission power detecting unit 213. The transmission power managing unit 3 receives the value of the transmission power of a communication operation using the WiMAX system from the transmission power detecting unit 223.

The transmission power managing unit 3 acquires the SAR value corresponding to the transmission power, which has been received from the transmission power detecting unit 213, from the transmission power and SAR correlation information 33. The transmission power managing unit 3 acquires the SAR value corresponding to the transmission power, which has been received from the transmission power detecting unit 223, from the transmission power and SAR correlation information 33. The transmission power managing unit 3 calculates the total sum of the acquired SAR values. Then, the transmission power managing unit 3 determines whether the total sum of the SAR values is greater than the SAR reference value 31. When it is determined that the total sum of the SAR values is greater than the SAR reference value 31, the transmission power managing unit 3 acquires information on a communication system having the highest priority and other communication systems from the priority table 32. The transmission power managing unit 3 instructs the protocol control unit, which performs a communication operation using a communication system other than the communication system having the highest priority, to lower the transmission power. For example, when the priority of the CDMA system is the highest and the priority of the WiMAX system is lower than that of the CDMA system in the priority table 32, the transmission power managing unit 3 instructs the protocol control unit 224 performing the communication operation using the WiMAX system to lower the transmission power.

Here, this embodiment does not use the priority application information 34, but an example using the priority application information 34 will be described in another embodiment.

On the contrary, when it is determined that the total sum of the SAR values is not greater than the SAR reference value 31, the transmission power managing unit 3 determines whether the protocol control units are being instructed to lower the transmission power. When it is determined that the protocol control units are not being instructed to lower the transmission power, the transmission power managing unit 3 continues to monitor the SAR. On the other hand, when it is determined that the protocol control units are being instructed to lower the transmission power, the transmission power managing unit 3 releases the instruction to lower the transmission power, which has been given to the protocol control unit conducting the instruction to lower the transmission power. Thereafter, the transmission power managing unit 3 continues to monitor the SAR.

The application executing unit 4 receives an instruction and the like to start up an application from the user interface 5 and executes various applications. In addition, the application executing unit 4 receives input data, which can be used in the applications, from the user interface 5.

When an application in execution communicates with an external device, the application executing unit 4 instructs the protocol control unit 214, which performs a communication operation using a communication system used by the application, to perform the communication operation. For example, in case of an application transmitting and receiving data using the WiMAX system, the application executing unit 4 instructs the protocol control unit 224 to transmit data when the application transmits the data.

In addition, the application executing unit 4 outputs output data based on the execution of the application or the like to the user interface 5.

The user interface 5 includes a liquid crystal screen, a keypad, a microphone, and a speaker. A user (hereinafter, referred to as an “operator”) of a mobile phone acquires and inputs data through the use of the user interface 5. For example, the operator inputs information through the use of the keypad or makes a voice call through the use of the microphone and the speaker while watching the liquid crystal screen. Data input from the user interface 5 is output to the application executing unit 4. In addition, data output from the application executing unit 4 is provided to the operator by the user interface 5.

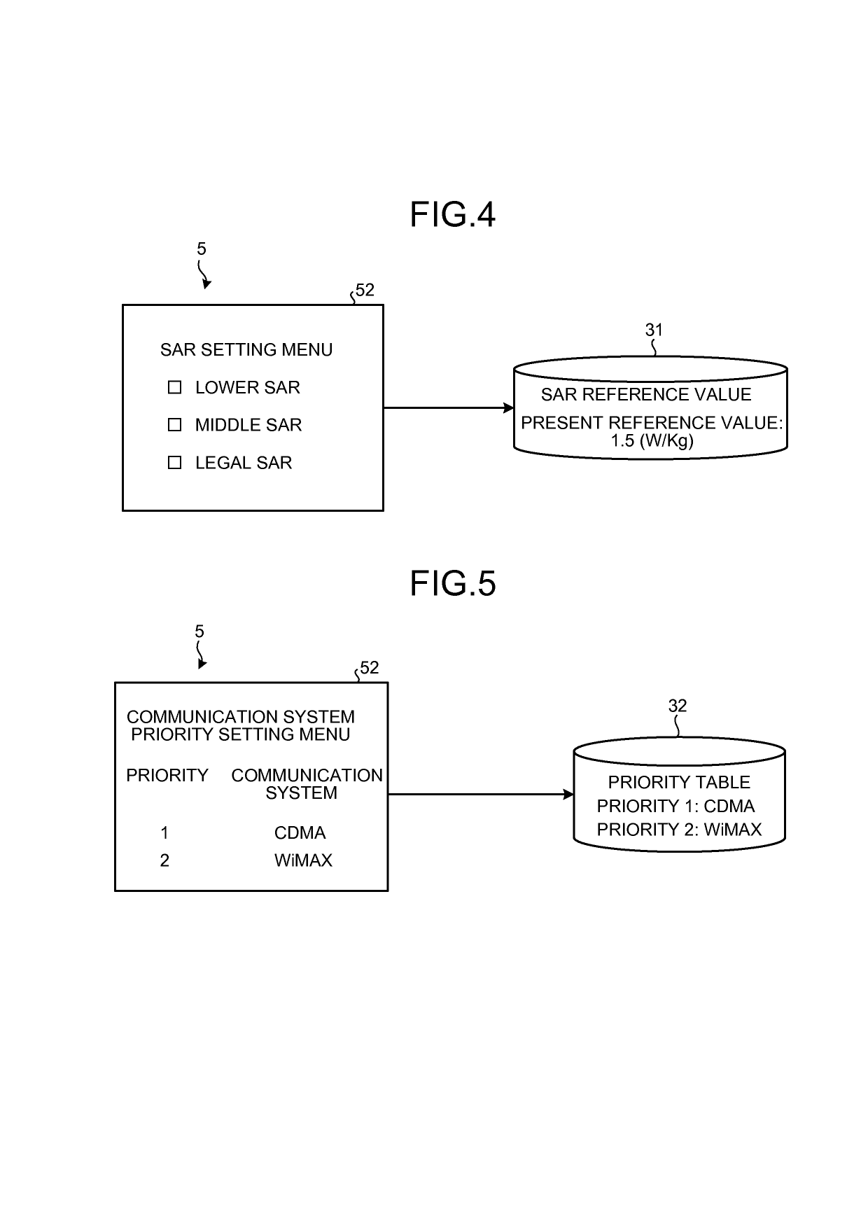

In this embodiment, the operator can set the SAR reference value and the priorities of communication systems, which are stored in the transmission power managing unit 3, through the use of the user interface 5. FIG. 4 is a diagram illustrating the setting of the priorities of communication systems. FIG. 5 is a diagram illustrating setting of priorities of communication systems.

When the SAR reference value is set, the user interface 5 displays a reference value setting screen 51 illustrated in FIG. 4 on the liquid crystal screen or the like. The reference value setting screen 51 includes an SAR setting menu used to set the SAR reference value. In this embodiment, for example, a low SAR, a middle SAR, and a legal SAR are displayed to be selectable in the SAR setting menu. The low SAR is the lowest SAR reference value which can be set in this embodiment and is set to further reduce the influence on a human body. In this embodiment, for example, the SAR reference value in the low SAR is 1 W/kg. The middle SAR is an SAR reference value which is higher than the low SAR but lower than the legal upper limit value, and is set to balance the influence on a human body and the communication stability. In this embodiment, for example, the SAR reference value of the middle SAR is 1.5 W/kg. The legal SAR is an SAR reference value which is the legal upper limit value and is set to give priority to the communication stability. In this embodiment, for example, the SAR reference value of the legal SAR is 2.0 W/kg.

The operator inputs the setting of a desired SAR reference value by selecting one of the low SAR, the middle SAR, and the legal SAR through the use of the keypad or the like. The user interface 5 outputs the input SAR reference value to the transmission power managing unit 3. Accordingly, the SAR reference value 31 stored in the transmission power managing unit 3 is rewritten and the SAR reference value is changed to the SAR reference value set by the operator. For example, FIG. 4 illustrates a case where the middle SAR is selected by the operator.

Here, the method of causing the operator to select a desired SAR reference value out of the predetermined SAR reference values is described in this embodiment, but the method of setting the SAR reference value is not limited to this method. For example, the operator may input a numerical value which is desired as the SAR reference value. The SAR reference value may be set by storing a file, which is used to set the SAR reference value and prepared by a maker of a mobile phone device or the like, in the transmission power managing unit 3 and causing the transmission power managing unit 3 to read the file. In this case, even when the mobile phone device is activated, it is preferable that it be made to easily set a reference value, for example, through the use of wired communication, wireless communication and a memory device (such as a memory card). The SAR reference value may be fixed so as not to change the setting of the SAR reference value.

When the priorities of communication systems are set, the user interface 5 displays a priority setting screen 52 illustrated in FIG. 5 on the liquid crystal screen or the like. The priority setting screen 52 includes a communication system priority setting menu used to set the priorities of communication systems. In this embodiment, for example, the priorities of the CDMA system and the WiMAX system are displayed to be selectable as the communication system priority setting menu. In FIG. 5, priority 1 represents a communication system having the highest priority and priority 2 represents a communication system having the second highest priority.

The operator inputs the priorities of the communication systems through the use of the keypad or the like. The user interface 5 output the input priorities of the communication systems to the transmission power managing unit 3. Accordingly, the priority table 32 stored in the transmission power managing unit 3 is rewritten and the priorities of the communication systems are changed to the priorities designated by the operator. For example, FIG. 5 illustrates a case where the CDMA system is set to the highest priority and the WiMAX system is set to the second highest priority by the operator.

Here, he method of causing the operator to set a desired priority through the use of the user interface 5 is described in this embodiment, but the method of setting priorities of communication systems is not limited to this embodiment. For example, the priorities of communication systems may be set by storing a file, which is used to set the priorities of communication systems and prepared by a maker of a mobile phone device or the like, in the transmission power managing unit 3 and causing the transmission power managing unit 3 to read the file. In this case, even when the mobile phone device is activated, it is preferable that it be made to easily set the priorities of communication systems, for example, through the use of wired communication, wireless communication and a memory device (such as a memory card). The priorities of communication systems may be fixed so as not to change the setting of the priorities of communication systems.

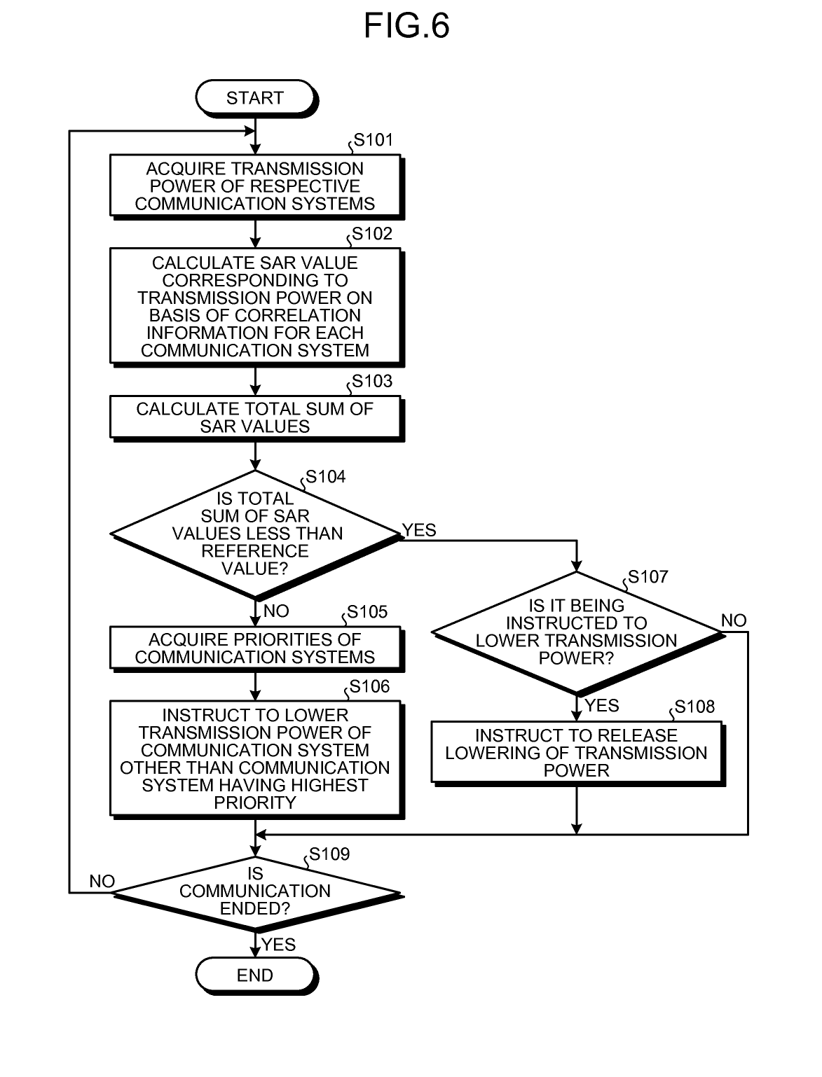

Next, the flow of processes of controlling transmission power in the mobile phone device according to this embodiment will be described below with reference to FIG. 6. FIG. 6 is a flowchart illustrating the flow of processes of controlling transmission power in the mobile phone device according to the first embodiment. Here, it will be described that the CDMA system and the WiMAX system are used as the communication systems and the priority of the CDMA system is the highest.

The transmission power detecting units 213 and 223 acquire the transmission power of the respective communication systems (step S101). The transmission power detecting units 213 and 223 output the acquired transmission power to the transmission power managing unit 3.

The transmission power managing unit 3 receives the transmission power of the respective communication systems from the transmission power detecting units 213 and 223. Then, the transmission power managing unit 3 acquires the SAR value corresponding to the transmission power for each communication system on the basis of the correlation between the SAR and the transmission power (step S102).

Then, the transmission power managing unit 3 calculates the total sum of the acquired SAR values (step S103).

Then, the transmission power managing unit 3 determines whether the total sum of the SAR values is less than the reference value (step S104). When it is determined that the total sum of the SAR values is greater than the reference value (NO in step S104), the transmission power managing unit 3 acquires the priorities of the respective communication systems from the priority table (step S105).

Then, the transmission power managing unit 3 instructs the protocol control unit, which corresponds to a communication system other than the communication system having the highest priority, to lower the transmission power of the communication system (step S106). Here, the transmission power managing unit 3 instructs the protocol control unit 224 to lower the transmission power of the WiMAX system. In response to this instruction, the protocol control unit 224 calculates transmission power by lowering the present value of the transmission power by a predetermined value and notifies the transmission power control unit 222 of the value of the transmission power lowered by the predetermined value. The transmission power control unit 212 controls the wireless control unit 11 to transmit data with the transmission power lowered by the predetermined value.

On the contrary, when it is determined that the total sum of the SAR values is not greater than the reference value (YES in step S104), the transmission power managing unit 3 determines whether the protocol control unit 214 or 224 is being instructed to lower the transmission power (step S107). When it is determined that the protocol control unit is being instructed to lower the transmission power (YES in step S107), the transmission power managing unit 3 releases the instruction to lower the transmission power, which has been given to the protocol control unit 214 or 224 instructed to lower the transmission power (step S108). Herein, the transmission power managing unit 3 instructs the protocol control unit 224 to release the lowering of the transmission power. On the contrary, when it is determined that the protocol control unit is not being instructed to lower the transmission power (NO in step S107), the flow of processes goes to step S109.

The respective system control units such as the CDMA system control unit 21 and the WiMAX system control unit 22 determine whether the communication operation is ended (step S109). When it is determined that the communication operation is ended (YES in step S109), the respective system control units such as the CDMA system control unit 21 and the WiMAX system control unit 22 end the control of the transmission power. On the contrary, when it is determined that the communication operation is not ended (NO in step S109), the respective system control units such as the CDMA system control unit 21 and the WiMAX system control unit 22 return step S101 and repeat the control of the transmission power.

Here, it is stated in this embodiment that two communication systems of the CDMA system and the WiMAX system are provided as the communication systems, but the communication systems are not limited to these two communication systems and another communication system or two or more communication systems may be used. For example, when two or more communication systems are used, the overall transmission power of the communication systems other than the communication system having the highest priority may be lowered at the same ratio, or the ratio at which the transmission power is lowered may be changed depending on the priorities.

As described above, when the SAR value generated in the wireless communication terminal device is greater than a reference value, the wireless communication terminal device according to this embodiment lowers the transmission power using the communication system having a low priority. Accordingly, even when communication operations are performed in parallel using plural communication systems, it is possible to suppress the SAR value to be less than a legal reference value and thus to observe the legal reference. Therefore, even when communication operations are performed in parallel using plural different communication systems, it is possible to reduce the influence of electromagnetic waves on a human body. By lowering the transmission power, it is possible to continue to perform all the communication operations in progress in parallel without interruption and thus to finish all the communication operations in progress.

In the first embodiment, when the total sum of the SAR values is less than the SAR reference value, the control of lowering the transmission power is released at once, but another method may be used. For example, as in the third embodiment to be described later, the transmission power managing unit 3 may calculate an estimated value of the transmission power from RSSI values, may calculate an estimated value of the SAR on the basis of the estimated value, and may release the control of lowering the transmission power when the total sum of the estimated values of the SAR values is less than the SAR reference value. The control using the estimated values of the SAR values will be described in detail in the third embodiment.

It is stated in the first embodiment that the transmission power is slowly lowered. However, for example, the transmission power managing unit 3 may monitor the variation in the total sum of the SAR values and may notify the protocol control unit of an instruction to stop the transmission of data using the communication system having a low priority when the total sum of the SAR values rapidly varies. In this case, the instructed protocol control unit stops the transmission of data. Accordingly, when the SAR value rapidly increases, it is possible to suppress the SAR value to be less than the reference value at once and thus to rapidly observe the legal reference.

### [b] Second Embodiment

A second embodiment of the invention will be described below. A wireless communication terminal device according to this embodiment is different from the wireless communication terminal device according to the first embodiment, in that the priorities used to determine the communication system of which the transmission power is lowered is replaced with priorities of applications. The functional blocks of a mobile phone device according to this embodiment are the same as illustrated in FIG. 1. In the wireless communication terminal device according to the second embodiment, the respective constituent units referenced by the same reference numerals as in the first embodiment have the same functions, as long as not particularly differently mentioned. The constituent units different from those in the first embodiment will be described below and the other will not be described.

The transmission power managing unit 3 calculates the total sum of the SAR values from the transmission power of the respective communication systems input from the transmission power detecting unit 213 and the transmission power detecting unit 223. Then, the transmission power managing unit 3 determines whether the total sum of the SAR values is greater than the SAR reference value. When it is determined that the total sum of the SAR values is greater than the SAR reference value, the transmission power managing unit 3 acquires the priorities of applications from the priority application information 34 (see FIG. 2). For example, a voice call application, an E-mail application, and a browser are included as the application.

Then, the transmission power managing unit 3 specifies an application other than the application having the highest priority. In addition, the transmission power managing unit 3 acquires information of the applications, which are used in the respective protocol control units, from the protocol control units 214 and 224. The transmission power managing unit 3 instructs the protocol control unit, which uses the specified application, to lower the transmission power. For example, when the communication systems of the CDMA system and the WiMAX system are used and the application other than the communication system having the highest priority uses the WiMAX system, the transmission power managing unit 3 instructs the protocol control unit 224 to lower the transmission power. In this case, in response to the instruction from the transmission power managing unit 3, the protocol control unit 224 inputs the lowered value of the transmission power to the transmission power control unit 222. The transmission power control unit 222 controls the wireless control unit 12 to satisfy the input value of the transmission power. In this embodiment, the transmission power managing unit 3 acquires the information of the applications, which are used in the protocol control units, from the protocol control units 214 and 224, but the method of acquiring information on which communication system the applications use is not limited to this method. For example, the transmission power managing unit 3 may acquire the information of the communication systems, which are used by the respective applications, from the application executing unit 4. As another method, the transmission power managing unit 3 may store the communication systems used by the respective applications in advance.

When the total sum of the SAR values is less than the SAR reference value 31, the transmission power managing unit 3 releases the instruction to lower the transmission power, which is given to the protocol control unit 214 or 224, similarly to the first embodiment.

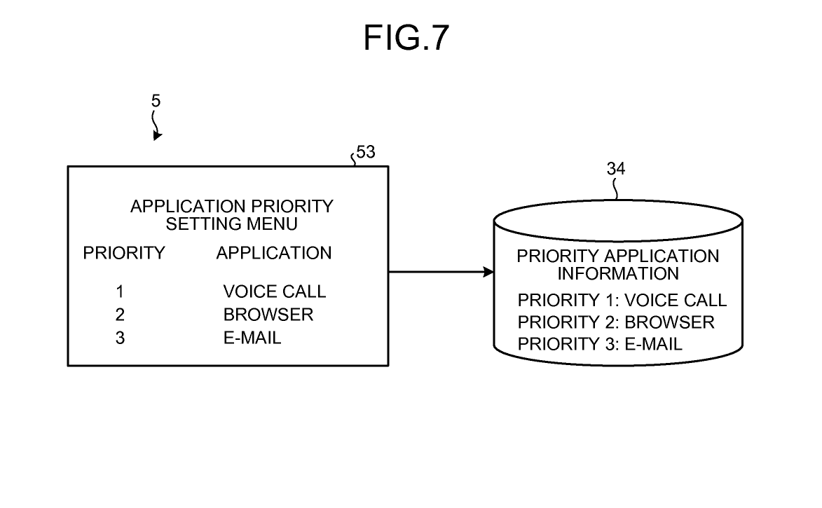

The setting of priorities of applications by an operator using the user interface 5 will be described below with reference to FIG. 7. FIG. 7 is a diagram illustrating the setting of priorities of applications.

When priorities of applications are set, the user interface 5 displays an application priority setting screen 53 illustrated in FIG. 7 on the liquid crystal screen or the like. The application priority setting screen 53 includes an application priority setting menu used to set the priorities of applications. In this embodiment, for example, priorities of applications such as a voice call application, a browser, and an E-mail application are displayed to be selectable in the application priority setting menu. In FIG. 7, priority 1 represents an application having the highest priority, priority 2 represents an application having the second highest priority, and priority 3 represents an application having the third highest priority.

The operator inputs priorities of the respective applications through the use of a keypad or the like. The user interface 5 outputs the input priorities of the respective applications to the transmission power managing unit 3. Accordingly, the priority application information 34 stored in the transmission power managing unit 3 is rewritten and the priorities of the applications are changed to the priorities designated by the operator. For example, FIG. 7 illustrates a case where the voice call application is set to the highest priority, the browser is set to the second highest priority, and the E-mail application is set to the third highest priority.

Here, in this embodiment, the method of causing an operator to set the desired priorities of the applications through the use of the user interface 5 is described, but the method of setting the priorities of the applications is not limited to this method. For example, the priorities of applications may be set by storing a file, which is used to set the priorities of applications and prepared by a maker of a mobile phone device or the like, in the transmission power managing unit 3 and causing the transmission power managing unit 3 to read the file. In this case, even when the mobile phone device is activated, it is preferable that it be made to easily set the priorities of applications, for example, through the use of wired communication, wireless communication and a memory device (such as a memory card). In addition, the priorities of applications may be fixed so as not to change the setting of the priorities of applications.

As described above, when the total sum of the SAR values is greater than the reference value, the wireless communication terminal device according to this embodiment lowers the transmission power of the communication system used by an application having a low priority. Accordingly, it is possible to suppress the transmission power of applications, the communication quality of which may be allowed to degrade, while guaranteeing the communication quality of the application considered to be important by the operator, and it is thus possible to lower the SAR values.

By the combination of the first embodiment and the second embodiment, that is, by the combination of the priorities of the communication systems and the priorities of the applications, the communication systems of which the transmission power is lowered may be determined. For example, the transmission power of the communication system other than the communication system having the highest priority and the communication system used in the application having the highest priority may be lowered.

### [c] Third Embodiment

A third embodiment of the invention will be described below. A wireless communication terminal device according to this embodiment is different from the wireless communication terminal device according to the first embodiment, in that the upper limit value of the transmission power of a communication system having a low priority is lowered when the total sum of the SAR values is greater than the reference value. The functional blocks of a mobile phone device according to this embodiment are the same as illustrated in FIG. 1. In the wireless communication terminal device according to the third embodiment, the respective constituent units referenced by the same reference numerals as in the first embodiment have the same functions, as long as not particularly differently mentioned. The respective constituent units different from those in the first embodiment will be described below and the other will not be described.

The transmission power managing unit 3 calculates the total sum of the SAR values from the transmission power of the respective communication systems input from the transmission power detecting unit 213 and the transmission power detecting unit 223. Then, the transmission power managing unit 3 determines whether the total sum of the SAR values is greater than the SAR reference value. When it is determined that the total sum of the SAR values is greater than the SAR reference value, the transmission power managing unit 3 specifies a communication system other than the communication system having the highest priority. In this embodiment, it is assumed that the priority of the CDMA system is the highest and the priority of the WiMAX system is the second highest. The transmission power managing unit 3 calculates a difference between the total sum of the SAR values and the SAR reference value and instructs the protocol control unit 224 using the WiMAX system to set the upper limit value of the transmission power to a value obtained by subtracting the calculated difference from the present transmission power.

In addition, the transmission power managing unit 3 acquires RSSI (Received Signal Strength Indication) values of the communication systems from the protocol control units 214 and 224. Then, the transmission power managing unit 3 calculates estimated values of the transmission power used in the communication systems from the RSSI values. In calculating the estimated values of the transmission power, for example, the transmission power managing unit 3 may store the correspondence between the RSSI and the transmission power and may acquire the transmission power corresponding to the RSSI. The transmission power managing unit 3 may store an expression for calculating the transmission power from the RSSI and may calculate the transmission power by substituting the received RSSI into the expression.

The transmission power managing unit 3 releases the setting of the upper limit value in the protocol control unit 224, when the total sum of the estimated values of the SAR values calculated from the estimated values of the transmission power used in the communication systems is less than the SAR reference value. Here, the releasing of the setting of the upper limit value may be performed by removing the upper limit or setting an upper limit value far greater than the transmission power for communication.

The protocol control unit 224 notifies the transmission power control unit 222 to set the received upper limit value as the upper limit value of the transmission power. The transmission power control unit 212 controls the transmission power of the wireless control unit 11 to be less than the designated upper limit value.

Here, it is stated in this embodiment that two communication systems are used, but two or more communication systems may be used. For example, the transmission power managing unit 3 acquires a value obtained by dividing the difference between the total sum of the SAR values and the SAR reference value by the number of communication systems other than the communication system having the highest priority. Then, the transmission power managing unit 3 instructs the protocol control units of the communication systems to set the value, which is obtained by subtracting the acquired value from the present transmission power, as the upper limit value of the transmission power.

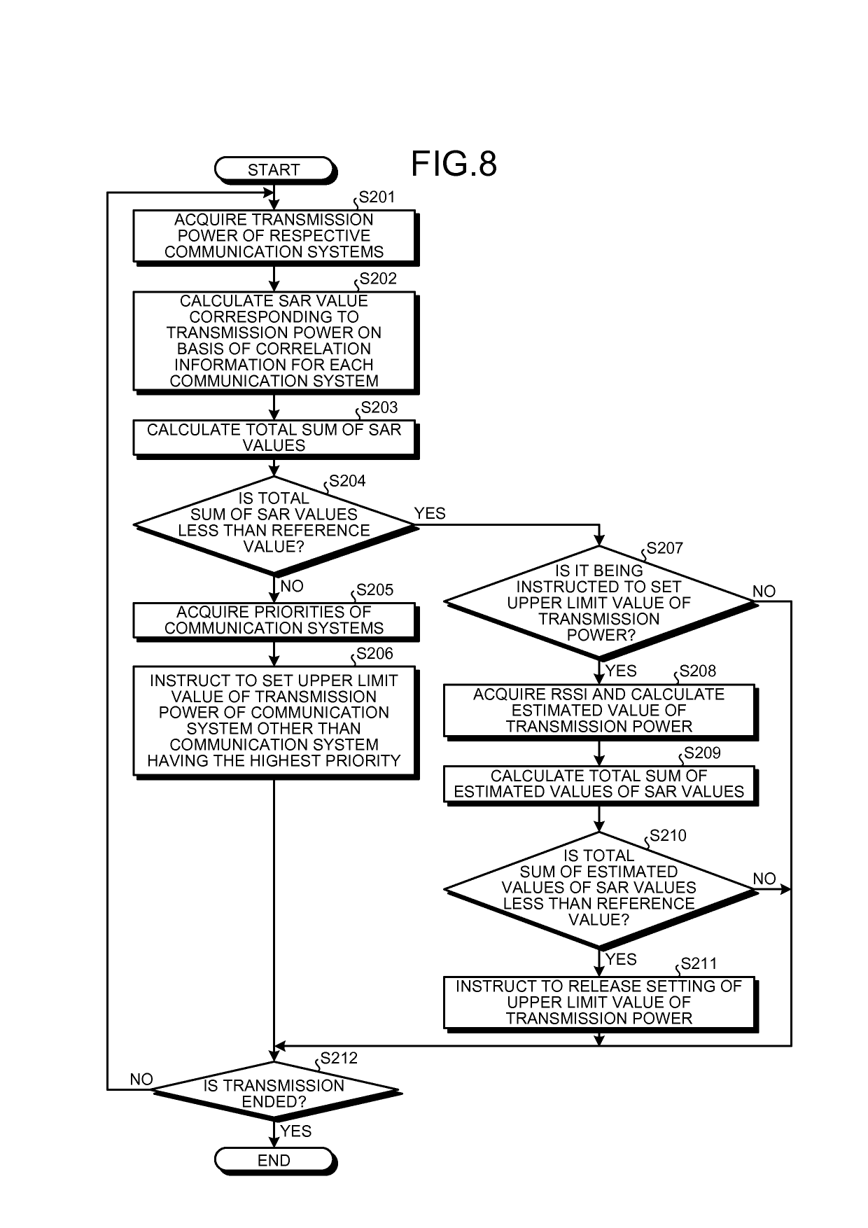

Next, the flow of processes of controlling transmission power in the mobile phone device according to this embodiment will be described below with reference to FIG. 8. FIG. 8 is a flowchart illustrating the flow of processes of controlling transmission power in the mobile phone device according to the third embodiment. Here, it is assumed that the CDMA system and the WiMAX system are used as the communication systems and the priority of the CDMA system is the highest.

The transmission power detecting units 213 and 223 acquire the transmission power of the respective communication systems (step S201). Then, the transmission power detecting units 213 and 223 output the acquired transmission power to the transmission power managing unit 3.

The transmission power managing unit 3 receives the transmission power of the respective communication systems from the transmission power detecting units 213 and 223. Then, the transmission power managing unit 3 acquires the SAR value corresponding to the transmission power for each communication system on the basis of the correlation between the SAR and the transmission power (step S202).

Then, the transmission power managing unit 3 calculates the total sum of the acquired SAR values (step S203).

Then, the transmission power managing unit 3 determines whether the total sum of the SAR values is less than the reference value (step S204). When it is determined that the total sum of the SAR values is greater than the reference value (NO in step S204), the transmission power managing unit 3 acquires the priorities of the respective communication systems from the priority table (step S205).

Then, the transmission power managing unit 3 acquires the upper limit value of the transmission power of a communication system other than the communication system having the highest priority and instructs the protocol control unit, which corresponds to the communication system, to set the acquired upper limit value (step S206). Here, the transmission power managing unit 3 instructs the protocol control unit 224 to set the upper limit value of the transmission power of the WiMAX system. In response to this instruction, the protocol control unit 224 notifies the transmission power control unit 222 of the setting of the upper limit value of the transmission power. The transmission power control unit 222 controls the wireless control unit 12 to transmit data with the transmission power less than the upper limit value.

On the contrary, when it is determined that the total sum of the SAR values is not greater than the reference value (YES in step S204), the transmission power managing unit 3 determines whether the protocol control unit is being instructed to set the upper limit value of the transmission power (step S207). When it is determined that the protocol control unit is being instructed to set the upper limit value of the transmission power (YES in step S207), the transmission power managing unit 3 acquires the RSSI values from the protocol control units 214 and 224. Then, the transmission power managing unit 3 calculates estimated values of the transmission power of the communication systems from the acquired RSSI values (step S208). In addition, the transmission power managing unit 3 acquires the estimated values of the SAR values corresponding to the calculated estimated values of the transmission power and calculates the total sum of the acquired estimated values of the SAR values (step S209). Then, the transmission power managing unit 3 determines whether the total sum of the estimated value of the SAR values is less than the SAR reference value (step S210). When it is determined that the total sum of the estimated values of the SAR values is less than the SAR reference value (YES in step S210), the transmission power managing unit 3 instructs the protocol control unit to releases the setting of the upper limit value (step S211). In this embodiment, the transmission power managing unit 3 instructs the protocol control unit 224 to releases the setting of the upper limit value of the transmission power.

On the contrary, when it is determined that the total sum of the estimated values of the SAR values is greater than the SAR reference value (NO in step S210) and when it is determined that it is not being instructed to set the upper limit value of the transmission power (NO in step S207), the flow of processes goes to step S212.

The respective system control units such as the CDMA system control unit 21 and the WiMAX system control unit 22 determine whether the communication operation is ended (step S212). When it is determined that the communication operation is ended (YES in step S212), the respective system control units such as the CDMA system control unit 21 and the WiMAX system control unit 22 end the control of the transmission power. On the contrary, when it is determined that the communication operation is not ended (NO in step S212), the system control units such as the CDMA system control unit 21 and the WiMAX system control unit 22 return step S201 and repeat the control of the transmission power.

As described above, when the SAR value generated in the wireless communication terminal device is greater than a reference value, the wireless communication terminal device according to this embodiment temporarily lowers the transmission power of the communication system having a low priority so that the total sum of the SAR values is less than the reference value. Accordingly, even when the total sum of the SAR values is greater than the reference value in the state where communication operations are performed in parallel using plural communication systems, it is possible to suppress the SAR value to be less than a legal reference value and thus to observe the legal reference.

Although it is stated in this embodiment that the upper limit value greater than the SAR reference value is lowered, another method may be used. For example, the upper limit value may be lowered by a predetermined unit value. In this case, since the upper limit value of the transmission power slowly varies, it is easy to cope with a case where the SAR value instantaneously increases due to instantaneous wireless degradation or the like.

### Hardware Configuration

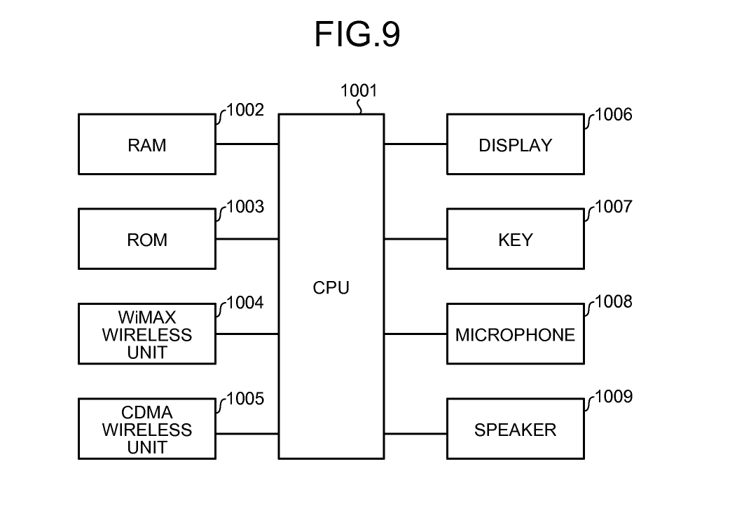

Next, the hardware configuration of the mobile phone described in the above-mentioned respective embodiments will be described below with reference to FIG. 9. FIG. 9 is a diagram illustrating the hardware configuration of a mobile phone.

The mobile phone in the respective embodiments includes a CPU (Central Processing Unit) 1001, a RAM (Random Access Memory) 1002, a ROM (Read Only Memory) 1003, a WiMAX wireless unit 1004, and a CDMA wireless unit 1005. The mobile phone in the respective embodiments further includes a display 1006, keys 1007, a microphone 1008, and a speaker 1009.

The RAM 1002, the ROM 1003, the WiMAX wireless unit 1004, the CDMA wireless unit 1005, the display 1006, the keys 1007, the microphone 1008, and the speaker 1009 are respectively connected to the CPU 1001 via a bus.

The WiMAX wireless unit 1004 performs a communication operation using the WiMAX system via an antenna. The WiMAX wireless unit 1004 embodies, for example, the function of the wireless control unit 12 illustrated in FIG. 1. The CDMA wireless unit 1005 performs a communication operation using the CDMA system via the antenna. The CDMA wireless unit 1005 embodies, for example, the function of the wireless control unit 11 illustrated in FIG. 1.

The display 1006 is constructed by a liquid crystal screen or the like. The keys 1007 include a keypad or other operation buttons. The display 1006, the keys 1007, the microphone 1008, and the speaker 1009 embody the function of the user interface 5 illustrated in FIG. 1.

The CPU 1001, the RAM 1002, and the ROM 1003 embody, for example, the functions of the CDMA system control unit 21, the WiMAX system control unit 22, and the application executing unit 4 illustrated in FIG. 1.

The RAM 1002 stores, for example, the SAR reference value 31, the priority table 32, the transmission power and SAR correlation information 33, the priority application information 34, and various applications.

The ROM 1003 stores, for example, various programs embodying the functions of the CDMA system control unit 21, the WiMAX system control unit 22, and the application executing unit 4 illustrated in FIG. 1. The CPU 1001 reads the programs from the ROM 1003 and creates and performs processes for embodying the above-mentioned functions.

According to one aspect of the wireless communication terminal device and the method of controlling a wireless communication terminal device disclosed herein, it is possible to reduce the SAR even when communication operations are performed in parallel using plural different communication systems.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication terminal device comprising:
a wireless communication unit that performs a plurality of communication operations in parallel using a plurality of different communication systems;
a transmission power detecting unit that detects transmission power in the communication operations using the respective communication systems performed by the wireless communication unit; and
a control unit that calculates the total sum of specific absorption rates in the respective communication operations based on the transmission power detected by the transmission power detecting unit and that controls the wireless communication unit to lower the transmission power of the communication operation using a predetermined communication system out of the plurality of different communication systems when the calculated total sum of the specific absorption rates is greater than a reference value.

2. The wireless communication terminal device according to claim 1, wherein the control unit stores correlation information indicating the relationship between the transmission power in the communication operations using the respective communication systems and the specific absorption rates, calculates the specific absorption rates corresponding to the transmission power of the respective communication operations detected by the transmission power detecting unit on the basis of the correlation information, and calculates the total sum of the specific absorption rates in the respective communication operations.

3. The wireless communication terminal device according to claim 1, wherein the control unit controls the wireless communication unit to lower the transmission power of the communication operation using the predetermined communication system by a predetermined amount.

4. The wireless communication terminal device according to claim 1, wherein the control unit controls the wireless communication unit to set up an upper limit value of the transmission power of the communication operation using the predetermined communication system so that the total sum of the specific absorption rates is less than or equal to the reference value.

5. The wireless communication terminal device according to claim 1, wherein the control unit determines the transmission power of the respective communication operations using the communication systems depending on predetermined priorities of the plurality of communication systems.

6. The wireless communication terminal device according to claim 5, wherein the control unit lowers the transmission power of the communication operations using the communication systems other than the communication system having a highest priority.

7. The wireless communication terminal device according to claim 1, further comprising:
an application executing unit that executes applications and that instructs the wireless communication unit to perform the communication operations to be performed by the applications,
wherein the wireless communication unit performs the communication operations in accordance with an instruction from the application executing unit, and
the control unit determines the transmission power of the communication operations corresponding to the respective applications depending on predetermined priorities of the applications.

8. The wireless communication terminal device according to claim 7, wherein the control unit lowers the transmission power of the communication operations corresponding to the applications other than the application having a highest priority.

9. The wireless communication terminal device according to claim 1, wherein the control unit calculates the total sum of the specific absorption rates in the respective communication operations on the basis of the transmission power detected by the transmission power detecting unit in a state where the wireless communication unit is controlled to lower the transmission power used in the predetermined communication operation and releases the control of the wireless communication unit to lower the transmission power of the communication operation using the predetermined communication system when the calculated total sum of the specific absorption rates is less than a predetermined reference value.

10. A method of controlling a wireless communication terminal device, comprising:
performing a plurality of communication operations in parallel using a plurality of different communication systems;
detecting transmission power in the respective communication operations;
calculating the total sum of specific absorption rates in the respective communication operations based on the detected transmission power;
determining the transmission power of the communication operations using the respective communication systems so as to lower the total sum of the specific absorption rates based on the respective communication operations when the calculated total sum of the specific absorption rates is greater than a predetermined reference value; and
performing the communication operations in parallel using the plurality of communication systems with the determined transmission power.
